(19) United States
(12) Patent Application Publication
(10) Pub. No.: US 2017/0100630 A1
(43) Pub. Date: Apr. 13, 2017

(54) Method and System of Movement

(71) Applicant: Regan Mizuno, Ham Lake, MN (US)

(72) Inventor: Regan Mizuno, Ham Lake, MN (US)

(21) Appl. No.: 15/292,097

(22) Filed: Oct. 12, 2016

Related U.S. Application Data
(60) Provisional application No. 62/240,831, filed on Oct. 13, 2015.

(51) Int. Cl. A63B 23/04; A63B 21/06; A63F 13/21; A63B 71/06; A63F 13/80; A63B 21/068; A63B 23/12

(52) U.S. Cl. CPC A63B 23/0405; A63B 21/068; A63B 21/0601; A63B 23/12; A63B 71/0619; A63F 13/80; A63F 13/21; A63B 2023/0411; A63B 2220/51

(57) ABSTRACT

An exercise system and method for assisting people with health conditions, including chronic conditions, during exercise, in reducing their discomfort, and without exacerbating their ailment, be it injury or other health condition, and potentially improving their condition and/or health. The present invention relates to methods and systems that reduce moment, shear, compression, tension, pressure, stress, impact, and the like. The present invention relates to a method and system of movement that can be performed by any individual including healthy individuals, as well as those individuals with health challenges, and that can also be performed from a chair, for example, or in a pool. The present invention may include the use of devices to assist with this movement methodology and system.

### CROSS-REFERENCE TO RELATED APPLICATION

This application claims the benefit of U.S. Provisional Application No. 62/240,831 entitled “Movement Method”, by Regan Mizuno, filed Oct. 13, 2015. This application also references U.S. Provisional application Ser. No. 13/623,108, entitled “Movement Method”, by Regan Mizuno, filed Sep. 19, 2012.

### BACKGROUND OF THE INVENTION

The present invention relates generally to movement, and more particularly to methods of movement that can be carried out by individuals with health challenges.

About one in every two American adults suffers from a chronic condition (Centers for Disease Control and Prevention). In 2005, 133 million Americans—almost 1 out of every 2 adults—had at least one chronic illness (Wu S Y, Green A. Projection of chronic illness prevalence and cost inflation. Santa Monica, Calif.: RAND Health; 2000). Also, as cited by the Centers for Disease Control and Prevention, chronic diseases are the leading causes of death and disability in the United States. The CDC states that:
7 out of 10 deaths among Americans each year are from chronic diseases. Heart disease, cancer and stroke account for more than 50% of all deaths each year.
Obesity has become a major health concern. 1 in every 3 adults is obese and almost 1 in 5 youth between the ages of 6 and 19 is obese (BMI 95th percentile of the CDC growth chart).
About one-fourth of people with chronic conditions have one or more daily activity limitations.
Arthritis is the most common cause of disability, with nearly 19 million Americans reporting activity limitations.

The CDC also cites common causes of chronic disease:
More than one-third of all adults do not meet recommendations for aerobic physical activity based on the 2008 Physical Activity Guidelines for Americans, and 23% report no leisure-time physical activity at all in the preceding month.

Currently, there is no exercise program for people with chronic pain that is gentle yet effective and includes respectable intensity.

Currently, the marketplace provides countless exercise instructional videos, websites, seminars, television shows and so on for members of the general population who do not suffer from chronic conditions. While many of these people may experience some issue, such as mild pain, including muscle or joint pain, or affliction, tendon injury, or other affliction which can be either permanent or temporary, they are still able to carry out exercise shown to them through such instructional videos. It is for those people that suffer from more serious, or from chronic injury or diagnosed conditions (which may be chronic) such as arthritis, fibromyalgia, multiple sclerosis, lupus, other chronic condition, or serious injury, that a specialized exercise method is needed and that is provided by the present invention. The present invention is an exercise method that is safe, and is doable. It includes movements that are safe (balanced, safe on joints) and that refrain from applying twisting motion, in order to be carried out. The exercises are functional and easy, yet effective. The exercises are gentle and can be high in intensity without being high in impact. It is applicable to those with pain or fatigue, and also to those without chronic conditions or pain or fatigue, that just want to exercise in a safe manner to protect their joints.

### SUMMARY OF THE INVENTION

The present invention provides a movement method for people with health issues or health concerns, including but not limited to chronic conditions, that is gentle yet effective.

The present invention includes safe motions to create a doable form of exercise and movement in daily life for those with chronic conditions, health challenges, health concerns, joint issues, injuries, and the like.

The present invention includes a method of movement that is helpful for those with chronic conditions, sports injuries, health problems, or the like.

The present invention can incorporate weights in combination with low-impact, yet respectable intensity, as well as aerobic activity.

The present invention includes reduction of moment during movement. The present invention includes reduction of moment during exercise.

The present invention includes reduction of negative factors for safe exercise and day-to-day living. The present invention includes reduction of tension, stress and the like in exercise.

The present invention includes ways and means to measure moment. The present invention includes a system to measure moment.

The present invention may include moving center of gravity, or weight, over a joint. The present invention may include a method for performing squats which comprises bending at the waist and at the knee such that the center of gravity of the body is moved over the knee or closer to the knee. The present invention may include a method of performing exercise by maintain center of gravity over the joint that hurts. The present invention may include a method of performing squats comprising bending at the waist and the knee while holding weights, wherein further comprising keeping the weights over the knee by adjusting the arm position. The present invention may further include simultaneously rolling on to the toes.

The present invention may include a device that helps detect moment on the joints. The present invention may include a device that detects moment or other effects further comprising analysis of the person and moment and other forces and recommendations for making adjustments to reduce moment or other negative effects.

An example of the present invention provides a high intensity workout, and thus allows people with chronic conditions to still be athletes.

An advantage of the present invention includes, but is not limited to, an exercise program that incorporates weights (or simply body weight) that includes a teaching method of showing people how to reduce moment (or other negatively impactful effects including shear, force, and other effects) themselves. By being aware of and modifying their position according to engineering principles, people benefitting from the disclosed method can increase the comfort of their workout, and allow themselves to indeed exercise, even though they may be facing pain. Another benefit of the present invention is that it allows people to work through and possibly improve their pain levels by exercise. The program shows people how to assess and/or change their body position according to center of gravity, body proportions of the individual, which of course vary from person to person, and other principles that can help them exercise. Even the smallest changes in a person's posture and/or placement of body weights or added weights make a difference in allowing the person to carry out exercise. Changing position can help reduce pain. A further advantage of the present invention is that the program assesses and shows the individual their limitations in terms of angles of motion and range of motion and other factors. The assessment can show the person when and in what way they are doing something incorrectly or inefficiently, and show them how to correct it. A device can assist in showing the person how to change their position or amount of weights or other factors. The method and device of the present invention can recommend a position of the body according to engineering principles. The present invention provides an exercise program that can be carried out from a chair or other assistive device, as well as from a standing position. Another advantage of the present invention is that the program can include aerobic and cardio exercise even if performed from a chair.

While some people with arthritis perform tai chi and water exercise, there is a lack of programs that teach people how to properly move according to their own body proportions. An advantage of the present invention is that it incorporates body proportions in the movement. It teaches people how to look at and utilize their body proportions to their advantage. Another advantage of the present invention is that it shows people how to create their own exercises and range of motion according to their own particular issues. The present invention teaches reduction of moment, and teaches engineering and physics principles. A further advantage of the present invention is that it teaches people how to modify the program for themselves according to their joints (or their muscles, tendons, or other parts of their bodies). The program is a teaching method to show people what is happening in the body according to force and other engineering principles.

These and other advantages of this invention will become clear from the following description by reference to the drawings.

### BRIEF DESCRIPTION OF THE DRAWINGS

FIG. 1 is an example of an exercise that prevents moment on the shoulder;

FIG. 2 is an illustration of an example of an exercise that creates moment on the shoulder. FIG. 2 also illustrates how moment is reduced (or eliminated) by putting weight over the joint that hurts (the joint that is in question). The same principles apply to shoulder as to knees (and all other joints in the body including hips, elbows, wrist and ankles);

FIG. 3 is an illustration of another example of an exercise that causes moment on the shoulder joint;

FIG. 4 is an illustration of how moment is created on the knee joint during a lunge;

FIG. 4a is an illustration of the reduction of moment on the knee. Note that when adding weights, by holding the weights over the knee, moment is reduced or eliminated;

FIG. 4b is an illustration of a knee joint showing moment and pressure point on the joint as a result of a smaller, and angled contact area on the joint during moment-causing exercise on the joint. The resultant contact area is smaller than it would be should the person be standing on a mostly straight leg. Pressure is increased on the knee during the bend as shown;

FIG. 5 is an illustration of a method of exercising the quad muscles of the leg without adding moment to the knee or hip joints by respecting center of gravity and keeping it over the knee;

FIG. 5a is a side view of a person performing a wall-squat wherein moment on the knee is significant;

FIG. 6 is an illustration of a unique method of performing squats that transfers weight (force) to prevent moment on the knees as the exercise is carried out. FIG. 6 also shows a unique method of performing a squat by keeping the weight over the knee, and by also keeping center of gravity over the knee;

FIG. 6a illustrates that a person can hinge at the hip more than what is shown in FIG. 6, and/or hinge less at the knee, in order to move the Center of Gravity more over the knee;

FIG. 7 is an illustration of a unique “soft jack” that prevents moment on the joints. This exercise can be performed from a chair; and

FIG. 8 is an illustration of one embodiment of a system that can detect and indicate body form.

FIG. 9 illustrates the definition of Torque: Force times distance.

### DESCRIPTION OF THE PREFERRED EMBODIMENTS

An example of the present invention is an exercise program that is based on teaching individuals how to mindfully prevent moment. The program is based on teaching individuals how to prevent adding moment, shear, impact, force, and other engineering principles and or negative effects to their bodies.

The exercise method provides reduction of any effect that will make exercise difficult to perform, including moment and the like. The exercise method can be carried out by people with chronic conditions, injuries, or other health issues or concerns. The program is safe for people to carry out and is gentle on the joints. The program shows people how to protect their joints while living their day-to-day lives and while exercising.

The present invention provides an exercise program that people can use to learn how to work with their specific type of joint injury (the nature and severity of joint injuries can vary from person to person). The present invention includes an exercise program that people can use to learn how to work for their own specific body proportions. The present invention incorporates center of gravity and calculation of moment and other engineering principles. Such engineering principles may include shear, torque, force, impact, pressure, resistance, strain, fatigue, other engineering principles and the like.

The present invention provides a device, of any kind, that assists in such an exercise program. The device can comprise a manual or electronic device.

For many of these individuals suffering from chronic conditions, exercise is recommended for both maintenance and improvement of health. However, for those individuals afflicted by such conditions, exercise becomes exceedingly difficult, if not impossible, to perform. This is due to the nature of their disease, which might include pain, limited range of motion, lack of energy, or other negative side effect. People with chronic conditions may suffer amputation or have limited eyesight and other problems as well.

The present invention can help reduce pain (and/or increases comfort) of a workout, allowing exercises to become doable.

The present invention method can allow people with pain or chronic or acute conditions to exercise. The present invention can provide a system that allows people with such issues to exercise.

Provided by the invention is a method by which exercise can be performed by those that have injuries, chronic conditions or other health challenges. The present invention provides an exercise method that is safe for those with such conditions. The present invention provides an exercise method that does not exacerbate existing conditions or create joint, muscle, or other issues.

The present invention includes a method that helps people use exercise machines in a mindful manner, incorporating knowledge they glean from such a teaching method to help them properly use the machine, and it provides a variable (modifiable) form of exercise that encompasses variations (low to medium to high intensity, for example, or “work”, or range of motion). The teaching method of the present invention can teach people how to modify exercise according to their particular needs and situation. Each person can be taught how to modify exercise to suit their body proportions and center of gravity. The present invention may provide coaching and methods of being mindful of the individual's own body proportions. The present invention may incorporate center of gravity principles in helping prevent or minimizing the creating of (bending) moment and twisting. An example of the present invention may include a method that incorporates high levels of intensity (as well as low and moderate) for those who want to and can do it.

Examples of the present invention may include programs for people that can help improve quality of life through reduction of inflammation. The present invention may include a diet and exercise (lifestyle) program. The present invention may include programs specific to certain conditions such as lupus, multiple sclerosis, fibromyalgia, polymyalgia rheumatic, and other diseases, conditions, health concerns, and issues.

The present invention pertains to movement that allows those with pain or health challenges to perform exercise. The present invention prevents exacerbation of existing issues, such as pain or joint problems. The present invention prevents joint injury, and can be performed by people with chronic conditions and other challenges. The present invention also pertains to methods of movement, for healthy individuals, that do not create potential problems such as joint injury or other problems in the future. The present invention overcomes the disparities in exercise for people with health conditions by providing an exercise method for people with health problems and chronic conditions. It is a method of exercise that is safe. The exercise method can be applied specifically to seniors. The exercise method reduces moment on the joints. The exercise method reduces moment on the muscles, tendons, bones, and other body parts. What is provided is a method of exercise to reduce moment, as well as other factors which may come in to play for the person's comfort and overall quality of life and lifestyle. Such factors may include force, impact, tension, compression, stress, wear, fatigue, and any other factor. The exercise method teaches people what moment is, and how to reduce it. It teaches people how to modify their position (of themselves, and/or of the weights they use and other positions) to exercise safely (which may include how to minimize, reduce or eliminate moment, or how to reduce other engineering principles such as stress which may help reduce pain). It is an exercise method that teaches people about engineering. It is novel because it includes laws of physics and nature, and exercise.

Provided is a method of exercise that incorporates body proportions, center of gravity, and calculation of moment, and other engineering and physics, and laws of nature. The present invention teaches and incorporates in to exercise principles of shear, torque, force, impact, pressure, resistance, strain, fatigue, and other engineering principles. The present invention provides devices that assist in such an exercise program. The device can comprise the use of a manual or electronic device.

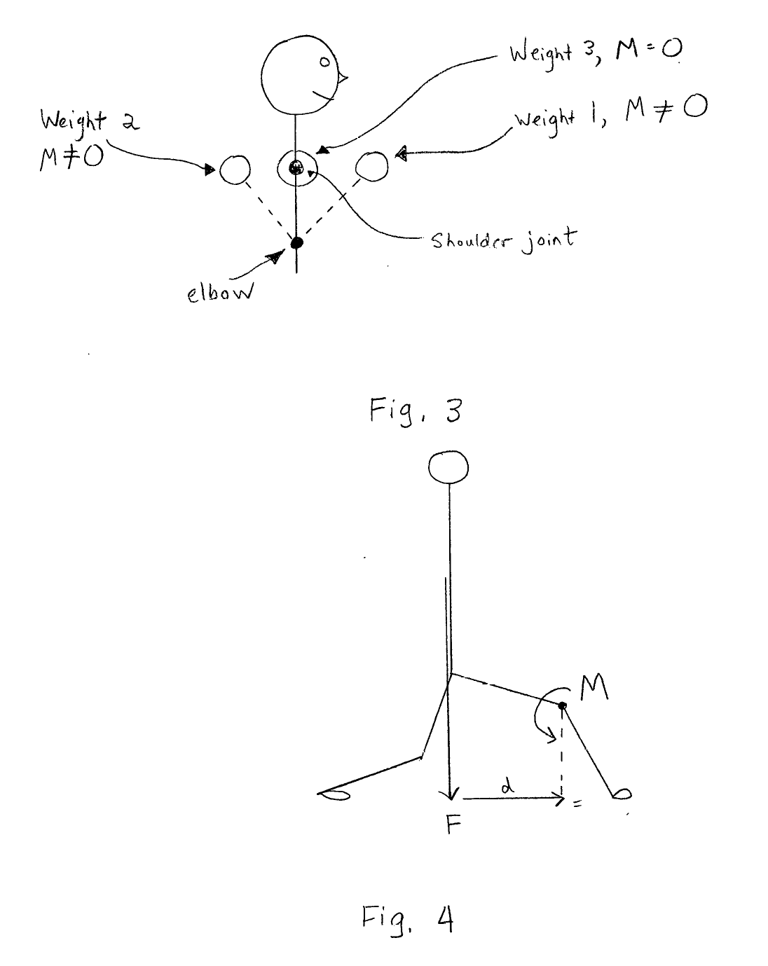

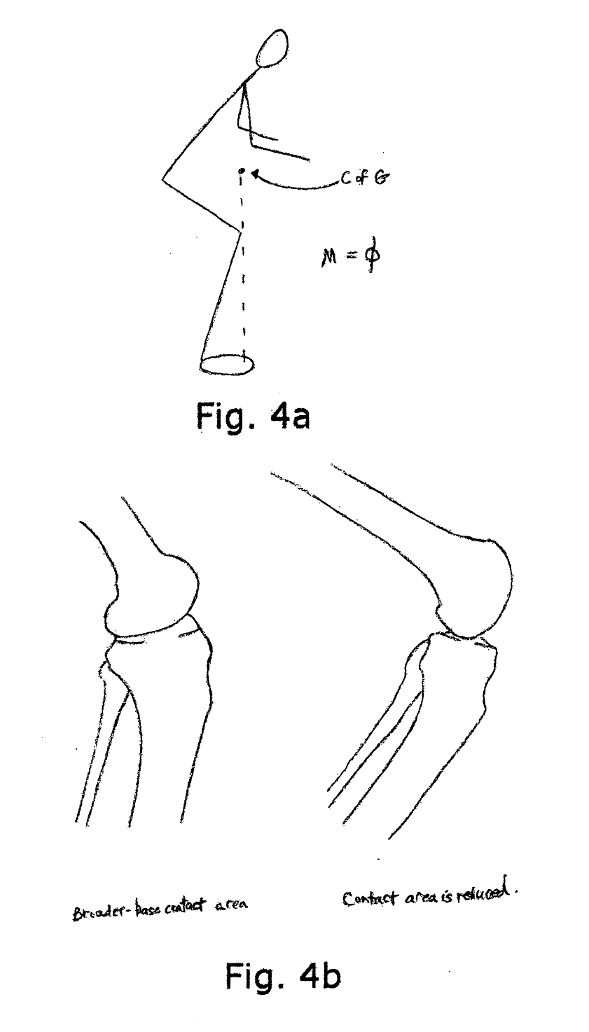

Commonly, resistance bands are used in exercising individuals having joint pain. However, resistance bands add strain and other issues to the joint/body part. When applied, resistance bands create tension on one side of the limb (and therefore on one side of the joint) and compression on the other. This results in strain, stress and moment. Stress and strain can lead to twisting, creating a pressure point on one part of the joint (see FIG. 4b regarding the knee, for example). This can be painful.

It feels better (less painful) to apply force over (on top of, above) the knee than to apply strain or moment. When using weights in a workout, (or one's own body weight) it is important to recognize where the weight should be placed, (be it placed over the knee, over the shoulder, or over another body part other for example) and that by changing the placement of the weight, different effects are being applied to the body and or the specific joint, tendon, or muscles. For example, alternating the location I placement of the weight will change whether the weight is applying simple force or also moment to the body part. When the weight is placed over the joint in question, there is force applied to the joint (and also to the muscle). A benefit of using free weights (or one's own body weight, for example), is that one can control the location of the weight. One can also control the heaviness of the weight and the way it is being held as well as its location).

Another important aspect of the present invention is it teaches people, based on the nature of the object they are dealing with, how to hold objects. For example, the present invention, which can be referred to as Regan Moves™, the Mizuno Method™, Regan Mizuno Method™, Regan Method™ or other such combination. The present invention explains to people how dumbbells can create moment on the wrists due to the distal displacement of the actual weight in relation to the “bar” portion of the dumbbell. Another example includes teaching people how to open Tupperware™ containers, jars, and continuing other day-to-day tasks in a manner that respects their joints and prevents twisting and undue negative impact (including shear, wear, etc.) on the joint.

What is provided is a method of teaching people about movement, and teaching them how to avoid or prevent or reduce moment or bending moment. The present invention teaches people how to work with their own body proportions. The present invention is an exercise program (method and system) that prevents moment.

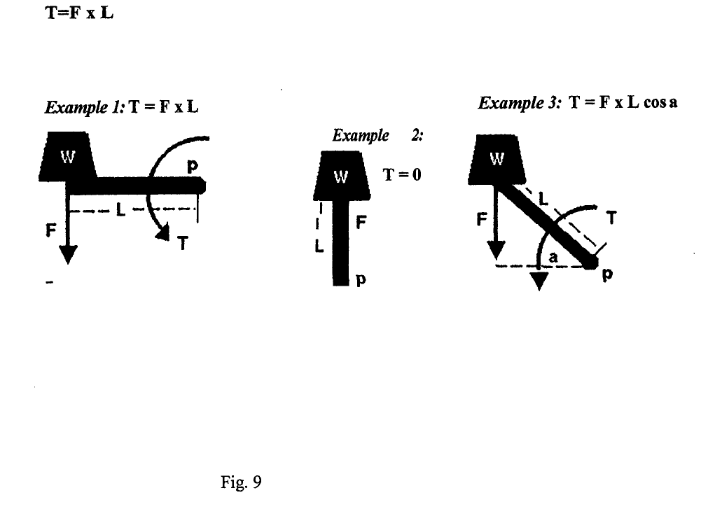

The Torque (T) about a point (p) is equal to the Force (F) times the distance measured perpendicular to the force. An illustration of this can be found in FIG. 9.

A person's body weight (plus any additional weights they may hold) may be thought of as “averaged” by the person, according to where their center of gravity is. Thinking of the application of weight according to the person's center of gravity simplifies their understanding and calculating of moment. Thus, the present invention shows people, according to their “eyeballing”, to identify their center of gravity. The present invention teaches people how to change their center of gravity. The present invention provides ways to change the center of gravity based on changing stance, putting out the butt bones, for example, arching one's back, squatting more or less, pivoting from the hips more or less, or altering height or squatting amounts. Then, the present invention shows people how to best place their center of gravity. The best placement of center of gravity may include placing it over the joint being worked. The best placement of center of gravity may be determined by where the person's pain is felt the least. The best placement of center of gravity may vary from individual to individual. The best placement of center of gravity may vary from DAY TO DAY for each individual, based on how they feel that day. Therefore, the present invention provides an exercise program that doesn't just show people what to do, but shows people how to modify their method of exercise (including their method of weight lifting or how they are standing or sitting in terms of body proportions) to work within their limits (their limitations, range of motion, situation) that day.

The present invention also provides a calculated way of precisely showing the center of gravity or other helpful alignment, force, shear, etc., or other effects. The present invention includes a device that helps identify the center of gravity and other effects.

In one embodiment, the individual is taught to keep their center of gravity over their pivot point (or over the joint that is involved, or over the joint that hurts). In this invention, it may also be taught that the person keep their weights (either added weight or body weight) over (or near) their center of gravity. With or without added weights, the person is shown where their center of gravity is. The person is then taught to try and keep their center of gravity over the joint in question as best they can. The person is taught to keep their added weight over the joint in question, or in a position such that their Center of Gravity is over the joint or in such a position that pain of the joint is reduced or eliminated.

For exemplary purposes only, refer to a simple squat. It would be beneficial for the person to maintain their center of gravity over the knee, if the person wishes to prevent moment on the knee (it would be beneficial to do so when there is pain involved in the knee or there is a desire to prevent joint injury to the knee). These methods are extremely beneficial to those that are involved in knee-heavy sports, including tennis and football.

The present invention provides methods to maintain joint safety for professional athletes. Referring to the example of performing a squat, it would be beneficial, should the person wish to protect their knee, for any added weights to also be held over the knee or at a position or in such a way that the Center of Gravity is over the knee or in a position where moment or pain on the knee is either reduced or eliminated. In another example, it may be beneficial for the person to hold the weights near the center of gravity. When holding the weights over the knee or other joint in question/of interest (including the shoulder, for example), moment is reduced or eliminated. The person may also hold the weight near the center of gravity. In certain positions, holding the weight near the center of gravity or holding it above the joint in question will result in the same positioning. The weight, if held over the knee for example (or the center of gravity), can be held at shoulder level, knee, hip, or other level. Referring to FIGS. 4 through 6, the weight is being kept over or near the knee as the squat is being performed. When holding weights, the weights will therefore be moved outwardly as the person bends deeper in to the squat, to keep the weights over the knees or at a position that maintains Center of Gravity over the knees (or at a position where the pain is reduced. At the same time, the person may also transfer weight to different parts of the foot to keep most of the body weight over the knees as well. This exercise could be called “Center of Gravity Squat”). This differs from what will later be described as the ROLLING or ROLL-DOWN SQUAT.

This method of reducing pain by using weights to change the location of Center of Gravity can be applied when using weight machines. For example, if the person has an idea of where their center of gravity is, or how they apply moment to the knees when using the adductor/abductor machine for example, they can alter how they position themselves, and how much weight they use, to create comfort during use of the machine. They can also learn which machines they choose to use or avoid during a certain pain level.

As such, provided is a functional exercise that can help people with chronic conditions improve their functionality day to day in daily activities.

Provided also is a method by which exercise can be performed by those that have injuries, chronic conditions or other health challenges. The present invention comprises an exercise method that is safe for those with such conditions and does not exacerbate existing conditions or create joint, muscle, or other issues.

The present invention provides a method and system that allows people with pain or chronic or acute conditions to exercise.

The present invention is a variable and modifiable form of exercise that encompasses variations (low to medium to high intensity, work, and range of motion). The present invention provides a method of teaching people how to exercise to prevent joint or muscle or tendon injury. It is therefore applicable to athletes as well as the chronically ill alike. Each person is shown how to modify exercise to suit their body proportions and center of gravity. The present invention provides coaching and methods of being mindful of an individual's own body proportions, center of gravity, and reducing or preventing moment, bending moment, torque, twisting, and other negative effects. The present invention provides high intensity safe workouts for those that want it.

Provided by the invention is a program for people that helps improve quality of life through reduction of inflammation. The present invention provides a diet and exercise (lifestyle) program. The present invention includes lifestyle programs specific to certain chronic conditions. The present invention provides alupus program, which includes an anti-inflammatory diet and low-moment exercise program. The present invention provides a low-heat, core, floor and mat program for multiple sclerosis patients. The present invention provides Regan Moves (or Mizuno Moves or the Regan method or Mizuno Method or JointSense) for arthritis, fibromyalgia, MS, and other chronic or other conditions. Regan Moves Yoga may provide yoga moves that reduce the distance of the legs within certain poses. This may decrease lever and therefore moment on the joints. Modified yoga according to the present embodiment may include transferring weight back and forth over the knee, which may be done in a continual fashion, so as to decrease the time when weights are not over a joint (the moment-inducing times). A rocking back-and-forth motion may be used in such a yoga move, and such a yoga program may be referred to as “Moving Yoga”, “Fluid Yoga”, “Movement Yoga”, “Mizuno (or Regan) Moves Yoga”, and so forth.

An improvement over a traditional lunge according to the teachings of the present invention may include alternating or shifting the person's body weight, possibly in a fluid, continual manner, from the hips to knees and the knees to the hips, creating less moment on the knee at an extended period of time when in the lunge. This movement would be conducted in a somewhat “rocking” motion, and comprises another example of the novel nature of the present invention.

The present invention provides workouts for seniors, chair workouts, specialized “jumping” jacks including (non-jumping) jacks, non-jumping jacks performed from a chair, a device that may find the center of gravity or detect or analyze a person's movements, the device may recommend alterations to the person's position, changes in the position of weights, the device may detect other effects such as where the force is, if there is any twisting being created, and so on.

The present invention therefore provides exercises that can be performed from a chair that aid in the reduction of moment and also aid in the ability of the exerciser to be able to carry out the exercise. The present invention may include methods of eating that can help reduce inflammation in the body. Combined with proper exercise techniques, an example of the present invention may provide a method of improving quality of life, especially for those with chronic and/or inflammatory and/or immune-related conditions. The present invention provides devices that help analyze movement and monitor inflammation, pain, and other markers of chronic disease.

The program includes exercise methods of reducing “moment”. In engineering, moment is the tendency of a force to cause rotation about a point. Torque, moment or moment of force is the tendency of a force to rotate an object about an axis, fulcrum, or pivot. This embodiment is about the reduction of moment on a joint or other body part.

The present invention also provides a device that measures or detects indicators to the person that would be valuable in reducing their pain. The device may show the person how to hold their body in an optimal manner, or show them how they are standing. The device may measure some factor or take a measurement that would help assess/change how the person carries out posture or movement.

The device may assess movement to help prevent pain. The device may provide information to assist movement. The device may provide information to help reduce moment. The device may be manual or it may be electronic.

During exercise it may be desirable to reduce shear force on a particular part of the body. It may be helpful to reduce compression or tension. Provided is a means of measuring all aspects and factors that can affect exercise such as bending moment, force, tension/compression ratios, strain, pressure, impact, and so on, and all factors that may affect a person's body parts including joints, muscles, tendons, and so on. The information can be used to help the person correct their posture and/or movement and/or range of motion, and other factors, to carry out the exercise (by reducing pain or increasing mobility, stretching, flexibility, or other positive methods of movement). These methods and devices will help the person lift weights, become more functional in day-to-day living, and be more able to stretch, reach, and become flexible. It essentially gives them their movement again.

Center of gravity may be used in the reduction of moment. Moment is a term used in aerodynamics to describe the tendency of a force to rotate a body under a given point-in the case of an airplane, usually the center of gravity,

The present invention may comprise assistive devices, which may comprise weights that reduce moment. For example, moment on a wrist can be reduced by providing a free weight that fits within the palm of the hand, thereby reducing distance from the wrist to a distal body (such as the weighted portion of a dumb bell when the dumb bell is being grasped by the hand). One example is a “ball bell”, wherein a weight is in the form of a graspable sphere. The ball-bell may comprise any material including as neoprene, plastic, and other material, and may be filled (to any weight) with any material, including liquids or other material. These are simply mentioned by way of example and a myriad of other devices can be incorporated into the program of Regan Moves.

The present invention may comprise a device, such as a video game. The device may comprise a monitoring system which may measure the person. The device may measure the person in all planes to detect forces, moment, and other effects on the body. The device may help show the person where they are applying MOMENT. The device may be customizable/programmable to the person. The person may input into the device the person's individual aspects. Such aspects may include height, weight, joints affected by pain, chronic conditions, injury or other affects, age, physical aptitude, concerns, and so on. The device may incorporate a limitless number of attributes of the individual. The device may comprise software that helps associate the person's attributes to a meaningful way of helping improve exercise. The device may include a display system.

The method may comprise center of gravity, force, moment, torque, perpendicular distance, and body proportions and the like in determining optimization of movement for the person.

The system may comprise center of gravity, force, moment, torque, perpendicular distance, and body proportions and the like in the determination of optimizing movement for the person.

The present invention can minimize or prevent bending moment, or twisting, and does not create other effects that might negatively impact the individual, such as undue stress, strain, tension, compression, force, shear, or other effects.

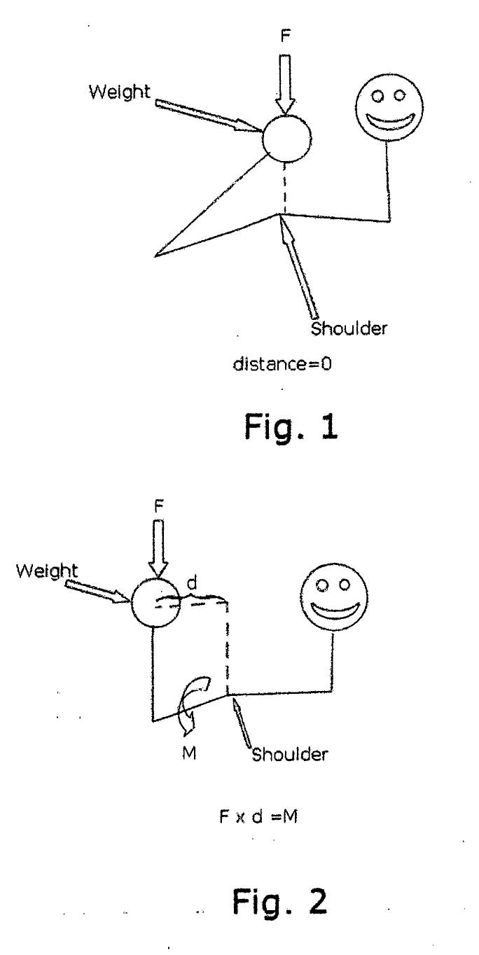

Referring to the drawings, FIG. 1 shows how applying force over the joint in question (the shoulder) eliminates moment by eliminating the perpendicular distance, d, from the applied force, F, to the shoulder.

In FIG. 2, a moment is created in the frontal plane by not having the weight over the shoulder.

FIG. 3 is a side view wherein moment is created in a different plane when the weight is not held over the shoulder. In FIG. 3, moment is created by the position of weight 2, and by the position of weight 1. Moment is eliminated by holding weight 3 over the shoulder in this plane.

Thus, to eliminate moment entirely, one simply holds the weight over the shoulder in all three planes if possible.

If this is not possible, moment can at the very least be greatly reduced simply by showing people how to calculate moment and how to modify their own body position.

Every person's body position will differ. This is because every person's body is different. Another novel aspect of the present invention is it incorporates varying body positions and proportions. Each person has a different ratio of bones to their other bones. Some people have a longer forearm than bicep portion, for example. This exercise method takes in to account everyone's body proportions.

Teaching people how to hold their body can show them exactly what forces, moment, and other effects are going on and therefore help them modify their position on their own to make exercise comfortable to them.

Referring to FIG. 4, a person creates moment on the knee by performing a lunge as shown in the right-most figure where the knee is being flexed. This can be extremely painful and damaging to the knee, because a pressure point is created (see FIG. 4b). To avoid future knee problems for those without chronic problems, or, for those with chronic issues such as arthritis, to allow exercise to be performed, it is more beneficial for the knee (and less painful), to keep the weight as closely over the knee, and to keep the center of gravity as closely over the knee, as possible. As shown in FIG. 4a, Moment is greatly reduced if not eliminated. Posture will vary, depending on the person's body proportions. Positions of weights will vary also, depending upon the body position, including such factors as how much the person is hinging at the hip. It is possible to hold the weights at such a distance as to act as a counterbalance or counterweight, that is, to hold the weight further beyond the knee, thereby changing the center of gravity, thereby reducing moment.

FIG. 4b shows a knee joint being stressed while moment is created by having force applied while the knee is in a bent position (as would occur during a lunge, for example).

The above are just a few examples to show how moment is created, and how it can be reduced. All exercises can be performed from a chair, adding another novel aspect to the present invention.

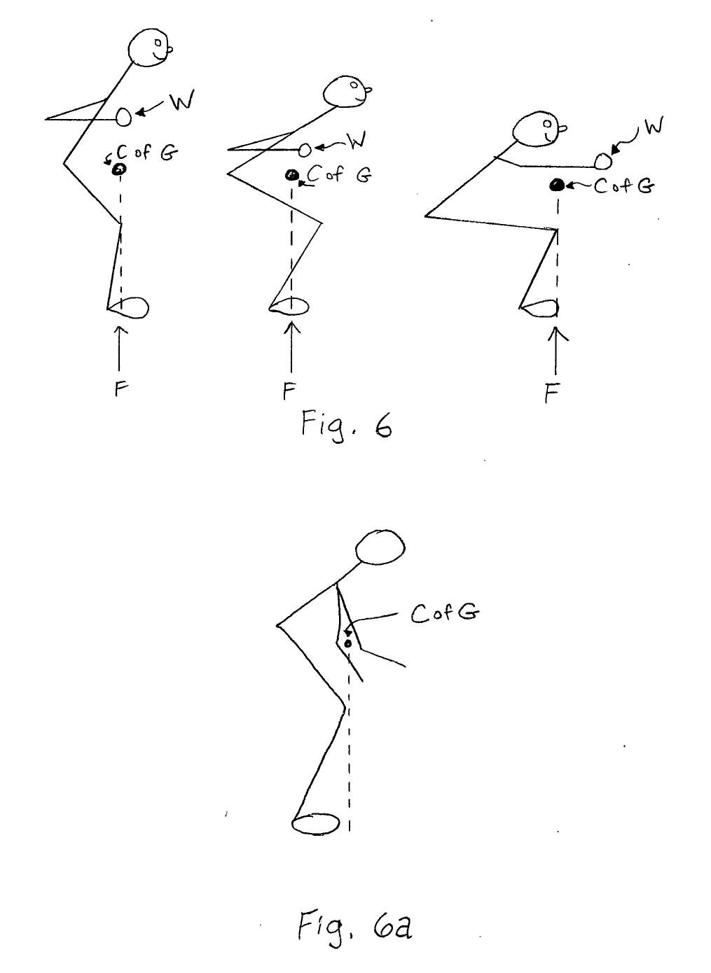

Moment is greatly reduced if not eliminated as shown by a person performing a specialized squat, called the “roll-down squat”, in FIG. 6. Referring to FIG. 6, the person leans forward in the squat. FIG. 6 shows a break in the person's hip, where the person leans forward. The shin and ball of foot is somewhat back, and the knee is sticking out. The person, by bending forward, moves their center of gravity nearer to, and possibly over, possibly directly above, the knee. This eliminates moment, and therefore pain, on the knee. Proper alignment is encouraged within the present embodiment of the invention. That is, according to the person's body proportions, and their skeletal angles and form and makeup, it is encouraged within the teaching method of the present invention that the person maintains proper bodily alignment. For example, if the person has a relatively straight or normal leg-hip-knee alignment, wherein the knee joint point mostly forward and the hip joint also points mostly forward, while performing a squat, for example, it would be beneficial for the person to maintain this proper alignment and keep their knee joint pointing relatively forward at the same time that their hip joint points relatively forward. This would be encouraged by the teaching method of the present invention. As well, should the person experience inwardly pointing knees, the person may be more properly aligned by keeping the foot turned out. The person will be shown how to respect the direction that their hip joint (and other joints) points. Joints need to be in alignment. The person will be taught to be mindful of such discrepancies (and will be shown how to work with them or tweak their alignment) within their own skeletal, muscular, and bodily makeup in order to maintain a proper alignment. Moment can be far more damaging if the person is out of alignment.

Maintaining proper alignment will help the person prevent or minimize moment. Maintaining proper alignment will also help the person prevent or minimize shear, pressure, impact, and the like.

Maintaining proper alignment, in all applicable body parts while conducting exercise, will help increase the comfort of the exerciser. The proper alignment will assist the person in the prevention of exacerbating skeletal (joint, muscle, tendon and the like) issues while performing exercise and daily tasks. As such, reducing moment, force, shear and the like as well as maintain proper body alignment will help the person carry out exercise and day-to-day tasks. This is a benefit of the teachings of the present invention. The person is encouraged to bend, or lean forward (hinge at the hip), while keeping a safe position of the back, as opposed to having an upright trunk posture during squats and bending movements. For example, squatting while maintaining an upright position of the trunk/torso wherein the trunk is close to being perpendicular to the plane of the floor, produces maximum moment on the person's knees, because the thigh portion is horizontal, while the back/torso/trunk is upright or vertical, resulting in a maximum amount of moment (and possibly other effects such as stress and the like) on the knee joint. When the center of gravity is moved forward (to a position that is mostly over the knee joint), by encouraging the person to bend, lean over (or hinge) at the hip, that the benefit is that the person is both keeping the leg bent and leaning the upper body forward (which is unique in comparison to how people traditionally perform squats). The person can improve the moving forward of center of gravity by doing other things such as arching their back. The person can also stick the bones of the gluteal (or pelvic) region “up” and out (arching one's back). Essentially, the person is compacting his or her body nearer to the knee.

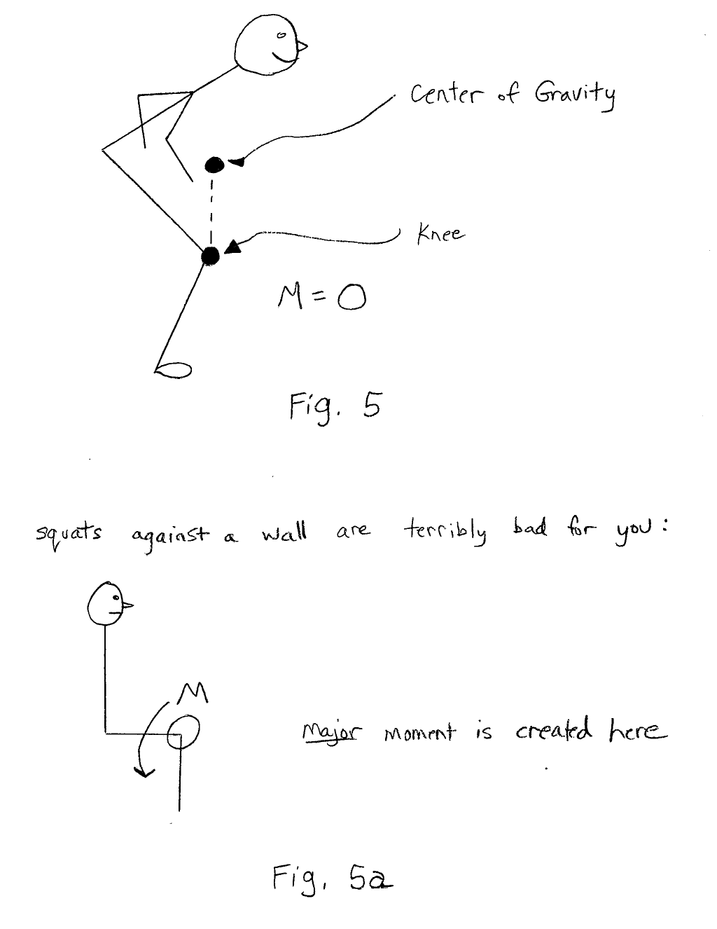

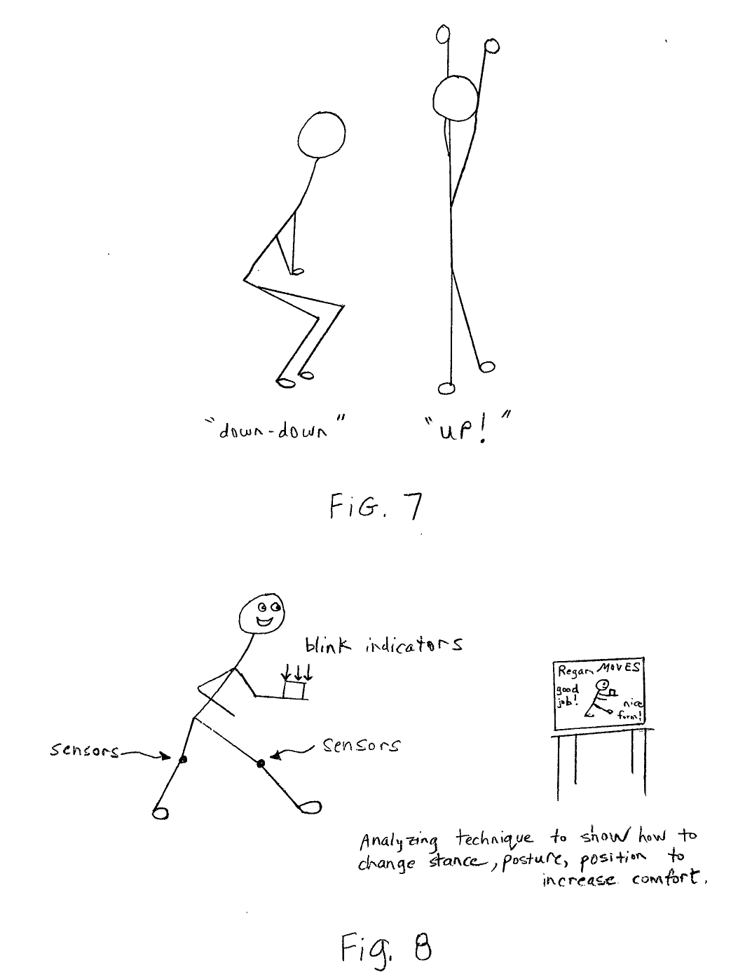

These are simply examples of one way a person can incorporate the present invention in their lives and increase the comfort of their workout and daily lives. The present invention encompasses all ways that will help a person increase the comfort of their daily lives while performing day-to-day tasks, including exercise. The same “leaning over” methodology can be seen in FIG. 7. FIG. 7 shows a specialized jumping or “soft” jack. Moment is at its greatest when performing a squat as shown in FIG. 5a (with the back straight and the center of gravity at a distance from the knee joint). In FIG. 5a, the moment on the knee joint is at a maximum because the center of gravity is a distance back from the knee. FIG. 5 illustrates the present invention reduction of moment. Here, the body is leaning forward. This helps maintain the center of gravity over the knee to reduce moment. Another way to move the center of gravity forward (away from the spine and closer to the knee) is to move any hand-held weights (or weights of the body or of a weight machine) forward over (or past) the knee as well as shown in FIG. 6. As the person moves lower in the squat and the knee moves forward, the person also moves forward their hand-held weights to keep them over the knee, or at a position such that the center of gravity is over the knee. The weights should be in a position such that comfort of the person is maximized, or such that the center of gravity remains directly above the knee. Usually the comfort of the person and center of gravity of above the knee go hand-in-hand. For comfort and/or maintaining center of gravity over the knee, the person may have the weights over (above) the knee, or further out, away from the knee, depending on the person's body proportions and so on. Again referring to FIG. 6, as the person moves deeper in to the squat, they can transfer their body weight (the force felt on bottom of the foot) and their center of gravity by conducting a rocking or rolling motion. The person may “rock” from the back of their foot to the ball of their foot to the front (or toe) of their foot as the move deeper in to the squat. This way, the force is felt under the knee. That is, the force is felt on the location of the foot that is under the location of the knee. As the person leans forward, this rocking motion can happen. The person can conscientiously move the force from the back portion of their foot to the middle portion of their foot to the front portion of their foot as they lean forward. This moves the center of gravity forward, over the knee (more vertically in line with the knee). Again, FIG. 7 is provided simply as an example and does not limit the present invention. The present invention includes but is not limited to movements as indicated in FIG. 7.

The above discussions of the drawing Figures are provided only as examples. The present invention is not limited to only such examples. The present invention provides methodology to reduce harmful effects on the body and to improve the way a person feels. Such effects can include moment, shear and the like. The present invention teaches people how to be mindful of such principles, including laws of nature, laws of physics, center of gravity, force, moment and the like, and apply them to functional living, as well as to exercise. Functional living includes performing day-to-day tasks.

The present invention provides a method of improving how the person feels by providing ways that help the person carry out day to day activities. Long term effects of exercise include anti-inflammatory effects. As such, the present invention provides a method of decreasing inflammation in the body.

Referring again to FIG. 6, the left-most figure has a center of gravity roughly over the knee because the body is fairly vertical. Referring to FIG. 7, the center of gravity stays there (mostly over the knee) because the person is leaning forward. In FIG. 6, the body on the right keeps the center of gravity over the knee also, even while holding weights, by moving the hands (or weights) as the person is bending over the knee. At the same time, the body is bending and keeping the center of gravity by holding the weights over or further out from the knee to keep center of gravity over the knee. An example of the present invention keeps the weights over the knee. In another embodiment the person keeps the center of gravity over the knee. In another invention, both the weights and the center of gravity are over the knee. This can be achieved by maintaining a bent torso position.

In an example of the present embodiment of the invention, the person keeps their center of gravity forward by rocking on the toe of the foot. That allows the person to stay in the bent (hinged at the hip) position. One cannot easily remain bent over if the weight is on the heels of the foot. The present invention provides an example where the person bends, or hinges, at the hips, which forces center of gravity forward and thereby keeps the person up, by moving the point of contact with the floor forward (by transferring weight, or rocking, from the back portion of the foot to the middle to the front portion of the foot). This maintains a straight line downward from the center of gravity through the knee to the foot. As the center of gravity moves forward to be over the knee, the weight is transferred from the back of the foot to the front of the foot. As this happens, the line from the center of gravity through the knee to the foot is continuous, (the result is a vertical line from the center of gravity through the knee to the foot), thereby reducing moment on the knee. If the person remains with the majority of their weight felt on their heels as the center of gravity is over the knee, the line is slightly not vertical. One gets closer to a straight line if one moves their contact with the floor forward (feeling the force change location from the back to the front of the bottom of the foot) as they deepen in to the squat. The center of the gravity and weight is above the knee if the person bends, and keeps the weights over (or forward of) the knee (keeps weights over or near the center of gravity).

In the “soft jack” shown in FIG. 7, the person needs not bend very far, and can bend at the hips as well as bend at the knees, to maintain a low-to-zero moment on the knees. The person may then simply stand and straighten up, to create a “jumping” jack that involves no jumping, and does not put moment on the knees. By simply straightening up, the person is moving the center of gravity up and down instead of forward and back. Upon straightening (standing up), the person many then simply stand, or they may jump, and/or the person may then do a traditional jumping jack portion where the legs are spread. This can be determined by the person, depending on how they feel that day. As long as they understand this embodiment of the invention, they can make the judgment as to how great a range of motion they want to carry out for themselves.

When leaning forward, the person is minimizing the moment (and creating low impact) during the exercise.

For the “soft jack”, the person my simply bend and stand where the feet don't leave the floor: in this way the exercise creates very low moment and also low impact.

Bending at the hip helps prevent moment. Bending at the hip helps prevent moment on the knees and hips. The location of the free weights can help prevent moment. Location of center of gravity and other portions of the body can help prevent or minimize moment.

A device may be used with the various embodiments of the present invention. A device may help show the person how they are creating moment, force, shear, and the like. The device may be similar to an interactive video game, such as dance games or other sports games, including Wii™, or the device may be similar to a golf-swing analyzer. The device may include an interactive controller or video game mat or other such device/system that can show the person's position and body alignment.

The device may include ways to measure where the person is, and what they are doing, using some electronic instrumentation. The instrumentation may be similar to the Wii™. This is just an example of how a device may be used with the teachings of the present invention and the present invention is not limited to using such devices.

The device may be manual or may be in the form of a watch or other attachable device to the person, for example.

In FIG. 6, when looking from the leftmost to rightmost figure, the sequence of motion is shown. As the person moves through the exercise, and lowers their body and deepens in to a squat, moment can be reduced by keeping the force, and center of gravity, as closely in line vertically with the knee joint as possible. For example, as shown in the leftmost drawing of FIG. 6, the weight, or force, is applied near the back portion, (heel or ankle area) of the foot. As the person moves in to the exercise, and the squat deepens, the force can be intentionally moved to the ball of the foot. This is done by the exerciser in a conscientious fashion, by thinking about placement of force. This helps maintain a zero or near-zero moment on the knee. As the person moves to the deepest position in the squat as shown in the right-most drawing of FIG. 6, the force can be transferred to the toe.

In addition, adding weights to the exercise can increase the intensity. By moving the weights forward, by moving the arm forward, the weights can also be kept in line with the center of gravity and force. As shown in FIG. 6, the person mindfully moves the weights in their hands forward as they deepen in to the squat. Essentially, the person is transferring weight (force) to keep the force, or majority of the force, or Center of Gravity, over the knee to reduce moment on the knee as the person moves through the range of motion of the exercise.

FIG. 5 shows how maintaining the center of gravity over the knee can help eliminate or greatly reduce moment on the knee. In the same respect, FIG. 5a shows how performing wall-squats, where a person's back is placed against a wall and they are performing knee bends, can put a tremendous amount of moment on the knees.

The same principles apply to every joint in the body including wrists and elbows. Such principles can be taught to people to show them how to properly open a jar of peanut butter, for example. If the person has wrist issues, they can reduce moment on the wrist by extending the elbow outwardly from the body when opening the jar. If the person has elbow issues, they can reduce moment on the elbow created by opening the jar by holding the elbow close to their body and allowing the wrist to do most of the work.

Such principles can be taught to people as applicable tools for everyday functions. Such functions include lifting grocery bags, picking up children, squatting in to a chair, and getting into and out of bath tubs. It is a tool for healthy, day-to-day living.

It may be considered counterintuitive to apply force over (or above) the concerned joint. However, it reduces or eliminates moment and undue pressure points, allowing the person to perform the exercise, and prevents creating and exacerbation of joint problems.

Regan Moves™ provides many cardio and aerobic exercises. An example of a Regan Moves™ cardio exercise is the “soft jack” as seen in FIG. 7. Instead of a traditional jumping jack, the person squats, transfers weight from one foot to the other in a “down-down” instruction, and then extends into a jumping jack in the “UP!” portion with arms up at sides or overhead. Other modifications include squatting, and then simply standing. The person can raise their arms. Other modifications include stepping in an upright position, and then extending arms out or up or overhead. At a certain tempo, this exercise raises the heart rate, thereby constituting cardio or aerobic exercise, and prevents impact on the joints. The purpose of this exercise is the reduction of moment, and the reduction of impact. This exercise is provided for example only, and is only one of many exercises provided by the present embodiment that are safe to perform.

FIG. 8 shows exemplary blink lights (or blink indicators) and messages from such a system that may indicate proper form and show corrections needed to attain proper form. The system can be tailored to each individual's needs and body proportions by, for example, having the person input settings such as body proportions, height, weight, and other settings or by having those settings read by the system. The system may include sensors that may include accelerometers, inclinometers, movement analyzers, positioning systems, or height sensors as well as detection methods for Center of Gravity, and a reading device may be connected to a display device which may include a visual display such as a monitor, or a device worn on the body, such as a wrist-worn device.

Regan Moves™ therefore provides a method of exercise that reduces impact on the joints. Regan Moves™ provides exercises that can be done from a chair. Regan Moves™ provides jumping jacks and other cardio exercises for a chair workout.

Regan Moves™ teaches the reduction of moment. Regan Moves™ provides exercise for people with chronic conditions. The exercises are special in that they do not exacerbate pain or muscular-skeletal problems such as joint problems or other problems. Regan Moves™ teaches measurable factors to people for better alignment, including location and placement of weights, better weightlifting skills, and movement skills. The measurable factors include posture, speed at which the person is moving, and/or moving weights, measured stress and strain and moment, force, and other effects on joints and tells the person how to adjust.

Regan Moves™ incorporates devices that can assist in detecting forces and other effects on the body. Any device can be used for detecting effects on the body. For example, using accelerometers can be helpful in measuring such effects. Mirrors, recording devices, and video equipment can be used as well, as can still and motion cameras, in 2 or 3 D, and any other device including all electronic devices that can measure effects. These devices can show the person their particular range of motion and limitations.

Manual devices such as protractors or other devices can be used to determine the person's effects or experiences during exercise as well. Such devices can also show the person their particular range of motion and any limitations they should incorporate during their workout.

An example of the present invention includes a method of analyzing movement and technique. Similar to golf-swing analyzers, Regan Moves includes devices that can help detect, analyze, and indicate to the person position, stance, proper motion, forces, moment, shear, strain, stress, fatigue, and all other effects to help improve their workout. The device may indicate to the person they should change stance or position or posture. The device may comprise a video game, a watch, accelerometers, positioning systems, or any other system that can accept input and create an output. The output may comprise a drawing or virtual presentation of the person. It may indicate when the person is in proper alignment. It may indicate when the person is in improper alignment. The output may comprise effects created during their workout (force, moment, distance, body proportions, and other effects). The device may indicate visually or audibly that the person is in improper alignment or needs to change, and the device many indicate how the person should change. The device may incorporate video games such as Wii Fit™ or other video games or other delivery systems or delivery methods. And a device may incorporate tracking devices. The device could show whether one was in a position to satisfy the lowest moment requirements (the output may comprise a drawing or virtual presentation of a person—such as “improper alignment” or range of acceptable values or alignment including acceptable range of motion which could be predetermined and set by the user). This is just an example of what the device might do and is exemplary only.

The device in accordance with an example of the present embodiment of the invention may measure amount of moment. A device could be programmed to watch for zero (or low moment) and when the person strays from that they receive a signal (in a similar manner of how the Wii™ does for the dance routine). The Wii™ and this description of this device is just an example of how a device might be used with the present invention and is not limited to any device.

The device can measure (using any additional device including accelerometers or inclinometers, for example) the person's position, moment, and the like during exercise for the shoulder, and all body parts, for example). It is not imperative that these particular devices be used, they are simply included of examples of devices or methods that can measure factors that will help a person properly and safely exercise with less pain.

As another example, and simply an example only, one way in which a device of the present invention could be used is that similar to golf analyzers, there may be an element of photography or video used, that may take video and compare it to proper golf swings. As such, the device could create photography or a video of the person and could tell the person how they are performing certain exercises, such as, for example, a squat.

The device may incorporate tracking devices. The tracking devices may track movement. The device may include sensors. The device may include wireless devices, including monitors or other devices on certain points within the body. Such points may include hands, wrists, joints, feet, shoulders, etc, and other body parts, that can be used in the creation of a model of the individual. The device may include stickers, similar to those suction cups used during ECG tests or to electrodes or devices used on the scalp to gain information from the exerciser. The device may include a wireless system, inclinometers, global positioning systems, accelerometers, other measuring devices, and any other component, wireless or otherwise.

The device may include a watch, or other indicator that can be worn on the person's body. Audio-visual feedback system (goggles or glasses, for example), or audio only or visual only methods and systems can be used.

The device may include any indicator, and may be used in the person's car, on their television monitor, radio, and so on, or any output device. The display device may comprise a screen which could include a television or computer monitor.

The device may assist in increasing the comfort and or joint safety during a workout. It is designed for people with chronic conditions to show them how to move.

The device may show people how to maximize their workout for maximum results. The device does not have to be electronic. It can comprise mechanical, body placement and body proportion measurable devices.

Regan Moves™ provides cardio exercises that can be done from a chair.

The present invention may comprise a method of eating and method of exercise to help improve quality of life. The present invention may comprise a method of eating and exercise to help reduce inflammation within the body.

The method by which pain can be reduced lies in the reduction of this twisting on the joints. There is currently no provided exercise method by which a person can reduce this bending moment, or one specifically designed for people with chronic conditions.

The present invention may comprise alternate pace and tempo of the exercise. The present invention may include workouts for people with chronic conditions. The present invention may include workouts to lessen impact (on joints, muscles, bones, tendons, and the like). The present invention may comprise workouts that lessen twisting on the body.

The present invention comprises showing people how to put the weight over the joint that hurts. This may cause the joint to hurt less while performing exercise or day-to-day tasks.

Other examples of the present invention include swaying the hips while performing a toe-tap exercise. The exercise could be called the “swaying toe tap”. By swaying the hips, one is creating a continuous fluid motion that helps reduce moment, impact, and the like on the joints.

Another example of the present invention is a “pulse squat” or “low-moment pulse squat” or “low-moment squat” or “safe squat”. The pulse squat may comprise small (pulse) squat-type movements that keep the center of gravity over the joint in question (the joint the person wishes not to exacerbate, or the joint that hurts, as the knee, for example) yet still comprise intense enough exercise to do “work” and increase the strength of the muscle.

The present invention may comprise a method of reducing pain while performing a leg squat by transferring energy such that said energy remains over the knee. The energy may be transferred from one spot on the foot to another as the person lowers in to the squat.

The present invention may include specialized stretches. An example of a stretch according to the present embodiment of the invention is a wrist roll during a shoulder stretch. The person reaches out their arm over their head, and as they stretch, having a straight arm, they twist the wrist in one direction, and then the other, to feel a different part of the shoulder stretch.

Another example of a stretch according to the present embodiment is a “special stretch”, which focuses on the hips and inner and outer thighs and hip flexors. The person sits on the floor. They bring in their legs and bend them in the same direction as one another. One leg is bent behind the person, and the other leg is bent in front of the person. The person then leans over the knee that is in front of their body, and then moves inwardly towards the central part of their body, continuing to lean over and stretch. The person may at the same time roll down their neck and/or touch their chin to their chest.

This stretches the inner and outer parts, and hip, of the leg that is behind the person. The person then reverses the legs (puts them in the opposite direction) and stretches in the same manner.

Another example of the present invention includes doing toe taps, wherein the person stands and alternates legs onto which they transfer their weight. As weight is transferred to one leg, the other leg is placed up on the toe. While performing the toe tap, the person can conscientiously sway or swing their hips. The result is a transfer in energy which is fluid, and helps reduce moment on the knees.

Cyclical motion helps prevent impact (when motion never stops, impact is lessened).

Other rolling methods can be used with examples of the present embodiment of the invention. Transferring weight in a rocking motion can help reduce moment.

Another example of an exercise of the present invention includes low-moment compound exercise. One example is incorporating legs and arms. One example includes a “punch” similar to a Taekwondo Karate Punch. The person may gently squat, and may bend over, or stay straight if they are able, and reach out in a punch that is a fluid punch. This reduces moment on the shoulders, wrists and elbows if they are mindful about arm bend and placement.

The present invention includes a method of exercise wherein the weight is predominantly placed OVER or on the joint that the person wants to protect (or the joint that hurts)—which prevents moment on that joint.

The present invention may include the use of a device that monitors where one puts weight. The device could be a camera, a weight itself, an accelerometer, or the like.

When weight is taken off a joint, it docs not disappear. As such, moment is created, because as one removes the weight off of the joint, one is moving it elsewhere. Therefore one creates a distance between where the majority of the weight is (the force), and the joint in question. Thus one is creating moment. Moment hurts more than direct weight, because there is twisting and grinding on the joint (See FIGS. 1 through 7).

The long-term effects of exercise can fight or reduce inflammation.

Increased cholesterol increases inflammation. Thus, the diet, which controls cholesterol levels, helps prevent an increase in inflammation. So the diet helps prevent against coronary artery disease. But the main thing here is: the diet can help reduce PAIN. And increase quality of life.

The present invention comprises a method of exercise that reduces pain. The method involves learning how moment works, and how not to hold one's body and/or weights when exercising. The present invention comprises a method of reducing pain while exercising. The present invention may include reducing twisting. The present invention includes a device that may measure information helpful in showing the person how to position themselves and/or weights. The device may measure the location of the person's (exerciser's) center of gravity, where forces exist, or the like, torque, force, shear, or other measurable affect. The device may comprise a wearable device. The device may comprise a watch or similar type of device or any other type of device. The device may simply be a video-game type of device.

The present invention may show the force and so on acting on the person, and if they are off balance or out of alignment, and it may indicate the person's body proportions.

Mechanical device that can measure your center of gravity—a ball on a string, or pendulum. So you have to know how to exercise so it DOESN'T HURT.

This is a method of exercise that reduces pain or allows you to exercise with a painful joint. Exercise so it doesn't hurt-so for each person, it might be reducing moment, it might be reducing force.

The present invention includes a device on pain detection. The device may measure pulse, blood pressure, it may monitor eye movements, or utilize other methods to detect pain. The device may include the rate at which pulse goes up. It may indicate how to correct what is causing the pain.

Indicate pain—a person will stop what they are doing upon indication of pain, so that will train the person not do it that way. Or, at least it shows the device where YOU have to stop. You create your own PARAMETERS and limits on your range of motion. Detects your limits to set up a range of motion for YOU as an individual.

The teachings of the present invention may be applied to yoga, martial arts, any sport, and any condition including MS, diabetes, arthritis, fibromyalgia, lupus, and the like.

A benefit of the present invention is the reduction of cycles on the joints. By using weights, the person can increase their intensity of their workout. It would take a lot of aerobic activity (without weights) to achieve the same result. When working out properly (reducing moment and the like), the person can be fit and have health in a joint-friendly manner. The present invention is customizable for different people. For example, the teachings of the present invention could be applied to those with MS, where the core temperature must remain cool. The present invention allows for customizable workouts to meet each individual's needs.

The present invention teaches people how to be mindful of the different planes (working in three dimensions).

The present invention is applicable to those who are overweight, those who have or are awaiting joint replacement, those who have had strokes, and those with health problems.

The teachings of the invention can be applied to different parts within the joint. For example, the moment can be respected, as can other effects such as work, fatigue, stress, shear, tension, compression, and the like, for small parts of the knee, as an example (not just of the overall knee joint itself).

The present invention can be used for people with sports injuries, people with chronic fatigue, those that have physical needs but like physical challenge, and anyone else.

The present invention helps lessen the risk of injury, be the injury due to health conditions including stroke and the like, sports injuries, or any other type of accident or injury.

The present invention encompasses an exercise method that is low torque even in a cardio sense or in a constant movement sense (not just in terms of weights); that is, the exercise method involves movements that avoid twisting and encourages moving within the frame of the body and moving appendages within the frame of the body (even during cardio or dance-like or constant movement segments). For example, the invention encourages keeping the knees pointed in the same direction as the feet, conducting no sudden twists or turns or changes in direction, and it encourages avoiding torsion and shear force on the knee which can be caused by such movements. In Regan Moves™, the person is aware of how far out and in what direction and what manner they are extending their appendages during cardio or other segments. And the person is taught to be very aware of how far apart their feet are. The method keeps movement within the frame of the body, and not extending feet out too far (which can cause undesirable effects such as torque, shear, pressure, stress, flexion, rotation or other undesirable effects) in the body including in the hips, and especially in the knees. Facing forward. Or, when changing direction, to have the entire body change direction or turn, including the feet, body is facing the direction the feet are pointing, to avoid twisting of the trunk, hips and knees.

The previous discussions are provided as examples only and are not limiting to the scope of the embodiments set forth. The foregoing description of the invention has been presented for purposes of illustration and description and is not intended to be exhaustive or to limit the invention to the precise form disclosed, and obviously many modifications and variations are possible in light of the above teachings. As many changes are possible to the embodiments of this invention utilizing the teachings thereof, the descriptions above, and the accompanying drawing should be interpreted in the illustrative and not in the limited sense.

The program teaches those with pain or other health issues how to mindfully exercise. These methods can help prevent injury. They can also help decrease inflammation, adding to the person's overall health. They can help prevent obesity, help maintain a healthy lifestyle, and promote strength which will add to the person's overall wellness.

Obviously, numerous variations and modifications can be made without departing from the spirit of the present invention. Therefore, it should be clearly understood that the form of the present invention described above and shown in the figures of the accompanying drawing is illustrative only and is not intended to limit the scope of the present invention.

What is claimed is:

1. A method of movement that reduces discomfort of a person.

2. The method of claim 1 wherein said step of reducing discomfort of said person further comprises reducing discomfort of an area of said person's body.

3. The method of claim 2 wherein said step of reducing discomfort of said area further comprises reducing force on said area.

4. The method of claim 1 wherein said step of reducing said discomfort further comprises reducing moment.

5. The method of claim 1 wherein said step of reducing said discomfort further comprises reducing torque.

6. The method of claim 1 wherein said step of reducing said discomfort further comprises reducing bending moment.

7. The method of claim 1 wherein said step of reducing said discomfort further comprises reducing shear.

8. The method of claim 1 wherein said step of reducing discomfort comprises reducing pressure.

9. The method of claim 1 wherein said step of reducing discomfort comprises reducing stress.

10. The method of claim 1 wherein said step of reducing said discomfort of said person further comprises adjusting body position of said person.

11. The method of claim 10 wherein said step of adjusting body position further comprises moving a limb.

12. The method of claim 10 wherein said step of adjusting body position further comprises moving a section.

13. The method of claim 10 wherein said step of adjusting body position further comprises hinging at hips of said body.

14. The method of claim 10 wherein said step of adjusting body position further comprises positioning body part over substantially over said area.

15. The method of claim 10 wherein said step of adjusting body position further comprises positioning arms over shoulders.

16. The method of claim 15 wherein said step of positioning arms over said shoulders further comprises positioning arms over shoulders in more than one plane.

17. The method of claim 1 wherein said step of reducing discomfort of said person further comprises adjusting location of a Center of Gravity of said person.

18. The method of claim 17 wherein said step of adjusting location of Center of Gravity further comprises positioning said Center of Gravity to provide reduction of moment.

19. The method of claim 17 wherein said step of adjusting location of Center of Gravity further comprises positioning said Center of Gravity to provide zero moment on an area of said person's body.

20. The method of claim 17 wherein said step of adjusting location of Center of Gravity further comprises positioning said Center of Gravity substantially over an area of the person's body that hurts.

21. The method of claim 17 wherein said step of adjusting location of Center of Gravity further comprises positioning said Center of Gravity near an area of the person's body that hurts.

22. The method of claim 17 wherein said step of adjusting location of Center of Gravity further comprises positioning Center of Gravity substantially over an area of said person's body in more than one plane.

23. The method of claim 18 wherein said step of positioning said Center of Gravity to provide reduction of moment on an area of said person's body further comprises providing an external force.

24. The method of claim 2 wherein said step of reducing discomfort of said area of the person's body further comprises utilizing an applied force.

25. The method of claim 2 wherein said step of reducing discomfort on an area further comprises reducing discomfort on a joint.

26. The method of claim 2 wherein said step of reducing discomfort on an area further comprises reducing discomfort on a muscle.

27. The method of claim 1 wherein said step of reducing discomfort of a person further comprises teaching said person to reduce distance of Center of Gravity from an area of said person's body that hurts such that moment is minimized on said area.

28. A system of reducing pain of an area of a person's body.

29. The system of claim 28 wherein said system of reducing pain of said area further comprises providing a system of reducing force on said area.

30. The system of claim 29 wherein said system of reducing force further comprises providing a system of adjusting Center of Gravity of said person.

31. The system of claim 28 wherein said system of reducing pain on an area of a person's body further comprises adjusting a Center of Gravity of said person to provide reduction of moment.

32. The system of claim 28 wherein said step of reducing pain of an area of a person's body further comprises positioning a Center of Gravity of said person to provide zeroing of moment on said area.

33. The system of claim 29 wherein said system of reducing force on said area further comprises providing a system of adjusting body position of said person.

34. The system of claim 28 wherein said system of reducing pain of said area further comprises providing an external force.

35. The system of claim 34 wherein said external force is a weight.

36. The system of claim 34 wherein said external force is a body part.

37. The system of claim 34 wherein said external force is a machine.

38. The system of claim 29 wherein said force is moment, also known as twisting force.

39. The system of claim 29 wherein said force is shear.

40. The system of claim 29 wherein said force is torque.

41. The system of claim 28 further comprising a device that measures force exerted upon said area of said person's body, feeds back said force by display mechanism to said person, notifies said person of said force.

42. The system of claim 28 further comprising a device that suggests methods to said person of reducing said pain.

43. The system of claim 38 further comprising a video game.

44. The system of claim 28 wherein the system includes a device that is a ball weight.

45. The system of claim 28 wherein the system includes a device that rotates so that as an angle of a body part changes as the person moves through a range of motion, the moment of that body part is reduced.

46. A method of movement that reduces discomfort of a person having a painful area comprising:
a) identifying an area of the person that is in pain,
b) providing a device for movement,
c) moving said device to provide a reduced moment with respect to that area

47. The method of claim 46 further comprising reducing said moment to zero with respect to that area.

48. The method of claim 46 wherein said step of reducing discomfort further comprises moving said person while maintaining center of gravity vertically in line with said area.

49. The method of claim 46 wherein said device is a body part.

50. The method of claim 46 wherein said device is a weight.

51. The method of claim 46 wherein said device is a machine.

52. The method of claim 46 wherein said step of identifying an area that is in pain further comprises detecting said pain by a pain detection device.

53. The method of claim 24 wherein said applied force comprises a weight.

54. The method of claim 24 wherein said applied force comprises a machine.

55. The method of claim 24 wherein applied force comprises a body part.

56. The method of claim 24 wherein said applied force comprises gravity.

57. The method of claim 1 wherein said step of reducing discomfort of a person further comprises said person moving in a body of water.
